(19) United States
(12) Patent Application Publication
(10) Pub. No.: US 2025/0199206 A1
(43) Pub. Date: Jun. 19, 2025

(54) MULTI-LEVEL STRUCTURED SURFACE FOR ANTI-GLARE APPLICATION AND ASSOCIATED METHODS

(71) Applicant: CORNING INCORPORATED, CORNING, NY (US)

(72) Inventors: Karl William Koch, III, Elmira, NY (US); Jun Yang, Los Gatos, CA (US)

(21) Appl. No.: 18/849,840

(22) PCT Filed: Mar. 16, 2023
(86) PCT No.: PCT/US2023/015335

§ 371 Date: Sep. 23, 2024

Related U.S. Application Data
(60) Provisional application No. 63/325,280, filed on Mar. 30, 2022.

(51) Int. Cl. G02B 1/11

(52) U.S. Cl. CPC G02B 1/11

(57) ABSTRACT

Described are display articles comprising a diffractive surface region formed in a major surface thereof. Within the diffractive surface region, the major surface comprises a plurality of regions disposed at a discrete distribution of heights measured relative to an imaginary base plane extending through the display article. The plurality of regions are arranged such that a specular reflectance of light incident on the first major surface within a wavelength range of interest [λₘᵢₙ, λₘₐₓ] at angles of incidence on the major surface in a range [θₘᵢₙ, θₘₐₓ] is reduced by at least a factor of 10 as compared to an untextured version of the first major surface not including the diffractive surface region. Differences between heights in the discrete distribution of heights are within 5% of integer multiples of Formula (I), where Formula (II), and Formula (III).

### PRIORITY

This application claims the benefit of priority under 35 U.S.C. § 119 of U.S. Provisional Application Ser. No. 63/325,280 filed on Mar. 30, 2022, the content of which is relied upon and incorporated herein by reference in its entirety.

### FIELD

The disclosure relates to anti-glare articles and, more particularly, to display articles comprising a surface with a diffractive surface region comprising a plurality of regions disposed at a discrete distribution of heights and arranged in a pattern based on a target scattering pattern.

### BACKGROUND

Substrates transparent to visible light are utilized to cover displays of display articles. Such display articles include smart phones, tablets, televisions, computer monitors, vehicle interior displays and the like. The displays are often liquid crystal displays and organic light emitting diodes, among others. The substrate protects the display, while the transparency of the substrate allows the user of the device to view the display. Glare is the phenomena associated with a degraded viewing experience in the presence of bright light sources. In addition, reflected images not from a bright light source but from the ambient can also contribute to a degraded viewing in displays. For example, a visually distinctive user's own reflected image, or light from the surrounding environment, can result in distraction, reduction in legibility, as well as visual fatigue.

Several techniques have been made to reduce glare, including anti-reflective coatings and anti-glare technologies. An anti-reflection coating can reduce glare, by directly reducing the total amount of reflection. However, certain existing anti-reflection coatings may fail to diminish reflections to a great enough extent throughout the visible spectrum to render such reflections unnoticed by users. Anti-glare technologies attempt to spread reflection of light to a large range of angles to reduce the peak intensity of the reflection and render distracting reflected images less distinct to the user. However, reflection at angles that are too large can result in relatively high haze that can reduce the contrast of the displayed images.

Accordingly, an alternative to existing anti-glare and anti-reflective coating technologies that allows favorable control of the angular distribution of scattered light would be beneficial.

### SUMMARY

An aspect (1) of the present disclosure pertains to a display article comprising: a first major surface; a second major surface opposing the first major surface; and a diffractive surface region formed in the first major surface. Within the diffractive surface region, the first major surface comprises a plurality of regions disposed at a discrete distribution of heights measured relative to an imaginary base plane extending through the display article and parallel to the first major surface. The plurality of regions are arranged such that a specular reflectance of light incident on the first major surface within a wavelength range of interest greater than or equal to a minimum wavelength λₘᵢₙ and less than or equal to a maximum wavelength λₘₐₓ at angles of incidence on the first major surface ranging from a minimum angle of incidence θₘᵢₙ to a maximum angle of incidence θₘₐₓ is reduced by at least a factor of 10 as compared to an untextured version of the first major surface not including the diffractive surface region. Differences between heights in the discrete distribution of heights are within 5% of integer multiples of λ̅/4, where

$$\overline{λ} = {( \frac{{λ}_{min}^{′ - 1} + {λ}_{max}^{′ - 1}}{2} )}^{- 1} ,$$

λ′ₘᵢₙ=λₘᵢₙ/cos θₘᵢₙ, and λ′ₘₐₓ=λₘₐₓ/cos θₘₐₓ.

An aspect (2) of the present disclosure pertains to a display article according to the aspect (1), wherein the diffractive surface region scatters the light in a far-field scattering pattern with a peak scattering angle that is less than or equal to 1.5° over the wavelength range of interest.

An aspect (3) of the present disclosure pertains to a display article according to the aspect (2), wherein the peak scattering angle is less than or equal to 0.5° over at least a portion of the wavelength range of interest.

An aspect (4) of the present disclosure pertains to a display article according to the aspect (2), wherein the far-field scattering pattern approximates a Laguerre-Gaussian mode.

An aspect (5) of the present disclosure pertains to a display article according to any of the aspects (1)-(4), wherein: λₘᵢₙ is greater than or equal to 380 nm and λₘₐₓ is less than or equal to 1200 nm, and θₘᵢₙ is greater than or equal to 0° and θₘₐₓ is less than or equal to 75°.

An aspect (6) of the present disclosure pertains to a display article according to any of the aspects (1)-(5), wherein λₘᵢₙ=400 nm and λₘₐₓ=800 nm.

An aspect (7) of the present disclosure pertains to a display article according to any of the aspects (1)-(6), wherein the specular reflectance is reduced by at least a factor of 100 as compared to the untextured version of the first major surface.

An aspect (8) of the present disclosure pertains to a display article according to any of the aspects (1)-(8), wherein the plurality of regions have a minimum feature size that is greater than or equal to 1 μm.

An aspect (9) of the present disclosure pertains to a display article according to any of the aspects (1)-(8), wherein the plurality of regions are arranged in a pattern that is periodic in two directions that are perpendicular to one another.

An aspect (10) of the present disclosure pertains to a display article according to the aspect (9), wherein the pattern comprises at least one surrounded region that is completely surrounded by regions having different heights relative to the imaginary base plane than the surrounded region.

An aspect (11) of the present disclosure pertains to a display article according to any of the aspects (1)-(10), wherein a transmitted haze of the light incident on the first major surface is less than or equal to 4% throughout an entirety of a wavelength range from 400 nm to 800 nm.

An aspect (12) of the present disclosure pertains to a display article according to any of the aspects (1)-(11), wherein the regions of the plurality of regions at each height of the discrete distribution of heights occupy a combined surface area percentage of the diffractive surface region that is predetermined to minimize the specular reflectance.

An aspect (13) of the present disclosure pertains to a display article according to the aspect (12), wherein the discrete distribution of heights comprises three or more heights.

An aspect (14) of the present disclosure pertains to a display article according to the aspect (13), wherein the discrete distribution of heights comprises at least four heights, the at least four heights comprising a minimum height hₘᵢₙ, a second height within 5% of hₘᵢₙ+λ̅/4, a third height within 5% of hₘᵢₙ+λ̅/2, and a fourth height within 5% of hₘᵢₙ+3λ̅/4.

An aspect (15) of the present disclosure pertains to a display article according to the aspect (14), wherein: a first plurality of regions having the minimum height occupy a first combined surface area percentage of the diffractive surface region, and the first combined surface area percentage is less than a second combined surface area percentage occupied by a second plurality of regions having the second height.

An aspect (16) of the present disclosure pertains to a display article according to the aspect (15), wherein: a third plurality of regions having the third height occupy a third combined surface area percentage of the diffractive surface region, a fourth plurality of regions having the fourth height occupy a fourth combined surface area percentage of the diffractive surface region, the first combined surface area percentage is within 5% of the fourth combined surface area percentage, and the second combined surface area percentage is within 5% of the third combined surface area percentage.

An aspect (17) of the present disclosure pertains to a display article according to the aspect (13), wherein the combined surface area percentage associated with each height is less than or equal to 40%.

An aspect (18) of the present disclosure pertains to a glass display article comprising: a first major surface; a second major surface opposing the first major surface; and a diffractive surface region formed in the first major surface, wherein, within the diffractive surface region, the first major surface comprises: a first plurality of regions comprising a first plurality of heights that are within 5% of an average of the first plurality of heights at a maximum height hₘₐₓ measured from an imaginary base plane extending through the display article and parallel to the first major surface, the first plurality of regions occupying a first combined surface area percentage of the diffractive surface region; and a second plurality of regions comprising a second plurality of heights that are within 5% of an average of the second plurality of heights at a minimum height hₘᵢₙ measured from the imaginary base plane, the second plurality of regions occupying a second combined surface area percentage of the diffractive surface region, wherein: the first plurality of regions and the second plurality of regions are arranged in a predetermined pattern based on a predicted specular reflectance of light incident on the first major surface within a wavelength range of interest greater than or equal to a minimum wavelength λₘᵢₙ and less than or equal to a maximum wavelength λₘₐₓ at angles of incidence on the first major surface ranging from a minimum angle of incidence θₘᵢₙ to a maximum angle of incidence θₘₐₓ, hₘₐₓ−hₘᵢₙ is within 5% of an integer multiple of λ̅/4, where

$$\overline{λ} = {( \frac{{λ}_{min}^{′ - 1} + {λ}_{max}^{′ - 1}}{2} )}^{- 1} ,$$

λ′ₘᵢₙ=λₘᵢₙ/cos θₘᵢₙ, and λₘₐₓ=λₘₐₓ/cos θₘₐₓ, and an average measured specular reflectance of the first major surface is less than or equal to 2.5% over the wavelength range of interest within the angles of incidence.

An aspect (19) of the present disclosure pertains to a glass display article according to the aspect (18), wherein diffractive surface region scatters the light in a far-field scattering pattern with a peak scattering angle that is less than or equal to 1.5° over the wavelength range of interest.

An aspect (20) of the present disclosure pertains to a glass display article according to the aspect (19), wherein the peak scattering angle is less than or equal to 0.5° over the wavelength range of interest.

An aspect (21) of the present disclosure pertains to a glass display article according to any of the aspects (19)-(20), wherein the far-field scattering pattern approximates a Laguerre-Gaussian mode.

An aspect (22) of the present disclosure pertains to a display article according to any of the aspects (18)-(21), wherein: λₘᵢₙ is greater than or equal to 380 nm and λₘₐₓ is less than or equal to 1200 nm, and θₘᵢₙ is greater than or equal to 0° and θₘₐₓ is less than or equal to 75°.

An aspect (23) of the present disclosure pertains to a glass display article according to any of the aspects (18)-(22), wherein, within the diffractive surface region, the first major surface comprises a third plurality of regions comprising a third plurality of heights that are within 5% of an average of the third plurality of heights at a height h₁ measured from the base plane, the third plurality of regions occupying a third combined surface area percentage of the diffractive surface region, wherein the height h₁ is within 5% of hₘᵢₙ+λ̅/4.

An aspect (24) of the present disclosure pertains to a glass display article according to the aspect (23), wherein, within the diffractive surface region, the first major surface comprises a fourth plurality of regions comprising a fourth plurality of heights that are within 5% an average of the fourth plurality of heights at a height h₂ measured from the base plane, the fourth plurality of regions occupying a fourth combined surface area percentage of the diffractive surface region, wherein the height h₂ is within 5% of h₁+λ̅/4.

An aspect (25) of the present disclosure pertains to a glass display article according to the aspect (24), wherein: the first combined surface area percentage is within 5% of the fourth second combined surface area percentage, and the third combined surface area percentage is within 5% of the fourth combined surface area percentage.

An aspect (26) of the present disclosure pertains to a glass display article according to the aspect (24), wherein each of the first combined surface area percentage, the second combined surface area percentage, the third combined surface area percentage, and the fourth combined surface area percentage are less than or equal to 40%.

An aspect (27) of the present disclosure pertains to a glass display article according to any of the aspects (18)-(26), wherein the first plurality of regions and the second plurality of regions each have a feature size that is greater than or equal to 1 μm.

An aspect (28) of the present disclosure pertains to a glass display article according to any of the aspects (18)-(27), wherein the predetermined pattern is periodic in two directions that are perpendicular to one another.

An aspect (29) of the present disclosure pertains to a glass display article according to any of the aspects (18)-(28), wherein the predetermined pattern comprises at least one surrounded region that is completely surrounded by regions having different heights relative to the imaginary base plane than the surrounded region.

An aspect (30) of the present disclosure pertains to a glass display article according to any of the aspects (18)-(29), wherein a transmitted haze of the light incident on the first major surface is less than or equal to 4% throughout an entirety of a wavelength range from 400 nm to 800 nm.

An aspect (31) of the present disclosure pertains to a method of forming a diffractive surface region of a substrate for a display article, the method comprising: determining a pattern for a plurality of regions on a first major surface of the substrate, wherein each region of the plurality of regions comprises a surface area disposed at a height measured relative to an imaginary base plane extending through the display article and parallel to the first major surface, wherein the plurality of regions comprises a discrete distribution of heights; disposing one or more etching masks on the first major surface that allow etching only on select regions of the first major surface for forming at least some of the plurality of regions; and after each etching mask of the one or more etching mask is disposed on the first major surface, contacting the display article with an etchant for a period of time so as form the plurality of regions comprising the discrete distribution of heights in the substrate, such that differences between the heights in the discrete distribution of heights are within 5% of integer multiples of λ̅/4, where

$$\overline{λ} = {( \frac{{λ}_{min}^{′ - 1} + {λ}_{max}^{′ - 1}}{2} )}^{- 1} ,$$

λₘᵢₙ is a minimum wavelength of a wavelength range of interest, λₘₐₓ is a maximum wavelength over the wavelength range of interest, [θₘᵢₙ, θₘₐₓ] defines a range of angles of incidence over which it is desired to minimize specular reflectance of the display article, λ′ₘᵢₙ=λₘₐₓ COS θₘᵢₙ, and λ′ₘₐₓ=λₘᵢₙ COS θₘₐₓ.

An aspect (32) of the present disclosure pertains to a method according to the aspect (31), wherein determining the pattern for the plurality of regions comprises determining an ideal combined surface area percentage for each height in the discrete distribution of heights using the following relation FA=1, where A is a vector having N entries, with N corresponding to a number of heights in the discrete distribution of heights, 1 is a unity column vector with N entries, and F is an N×N matrix, with each value Fᵢⱼ being computed as

$${F}_{ij} = {\int }_{{k}_{min}^{′}}^{{k}_{max}^{′}} \frac{dk}{k} cos ( k \cdot \frac{\overline{λ} ( i - j )}{2} ) .$$

An aspect (33) of the present disclosure pertains to a method according to the aspect (32), wherein determining the pattern for the plurality of regions comprises: generating an initial pattern for the plurality of regions; calculating an estimated far-field scattering pattern ũ (λ) by approximating incoming light as a uniform field and the diffractive surface region as only inducing a phase shift in reflected light; and updating the initial pattern to reduce a difference between ũ(λ) and a target scatting pattern u(λ) using an optimization algorithm.

An aspect (34) of the present disclosure pertains to a method according to the aspect (33), wherein the optimization algorithm minimizes the following objective function for the pattern P:

$$F ( P ) = \frac{1}{K} {\sum }_{k = 1}^{K} log ( \vert {\sum }_{( i , j )} {\tilde{u}}_{ij}^{*} ( {λ}_{k} ) \cdot {u}_{ij} ( {λ}_{k} ) \vert ) + w * {\sum }_{i = 1}^{N} {( {A}_{i} - {\tilde{A}}_{i} )}^{2}$$

where K is an integer value sampling the wavelength range of interest, i and j are integer values uniformly sampling the range of angles of incidence [θₘᵢₙ, θₘₐₓ], Aᵢ is the surface area percentage associated with a height in the discrete distribution of heights associated with the initial pattern, Ãᵢ is an ideal combined surface area percentage in the vector A, and w is a weighting factor.

An aspect (35) of the present disclosure pertains to a method according to the aspect (33), wherein target the far-field scattering pattern approximates a Laguerre-Gaussian mode.

An aspect (36) of the present disclosure pertains to a method according to any of the aspects (33)-(35), wherein the target scattering pattern comprises a peak scattering angle that is less than or equal to 1.5° over the wavelength range of interest.

An aspect (37) of the present disclosure pertains to a method according to any of the aspects (33)-(36), wherein the peak scattering angle is less than or equal to 0.5° over the wavelength range of interest.

An aspect (38) of the present disclosure pertains to a method according to any of the aspects (31)-(37), wherein the one or more etching masks comprises at least two etching masks such that the discrete distribution of heights comprises at least 4 heights.

An aspect (39) of the present disclosure pertains to a method according to the aspect (38), wherein: a second etching mask of the at least two etching masks is disposed on the first major surface after the substrate is exposed to an etchant through a first etching mask, and the second etching masks leaves an area of the first major surface etched through the first etching mask exposed so that the area is etched through both the first etching mask and the second etching mask.

An aspect (40) of the present disclosure pertains to a method according to any of the aspects (31)-(39), wherein the pattern comprises a minimum feature size that is greater than or equal to 1 μm.

An aspect (41) of the present disclosure pertains to a method according to any of the aspects (31)-(40), wherein the pattern is periodic in at least two directions that are perpendicular to one another.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a perspective view of a display article, according to one or more embodiments of the present disclosure;

FIG. 2 schematically depicts a plurality of regions of a diffractive surface region of the display article of FIG. 1, according to one or more embodiments of the present disclosure;

FIG. 3 schematically depicts a height profile of the diffractive surface region depicted in FIG. 2, according to one or more embodiments of the present disclosure;

FIG. 4A depicts a two-dimensional intensity map of a Laguerre-Gaussian mode, according to one or more embodiments of the present disclosure;

FIG. 4B depicts a one-dimensional intensity plot for the Laguerre-Gaussian mode depicted in FIG. 4A, according to one or more embodiments of the present disclosure;

FIG. 5A depicts a calculated optimal specular reflection suppression associated with patterns of regions at a plurality of heights as a function of a number of heights in a discrete distribution of heights, according to one or more embodiments of the present disclosure;

FIG. 5B depicts a calculated optimal specular reflection suppression associated with patterns of regions at a plurality of heights as a function of bandwidth of light for a plurality of discrete distributions of heights, according to one or more embodiments of the present disclosure;

FIG. 5C depicts a calculated specular reflectance associated with patterns of regions at a plurality of heights as a function of bandwidth of light for a plurality of discrete distributions of heights, according to one or more embodiments of the present disclosure;

FIG. 6A depicts a flow diagram of a method of identifying a pattern for a plurality of regions of a diffractive surface region, according to one or more embodiments of the present disclosure;

FIG. 6B schematically depicts a computing system that may be used to perform the method depicted in FIG. 6A, according to one or more embodiments of the present disclosure;

FIG. 7 depicts a flow diagram of a method of fabricating a diffractive surface region of a display article, according to one or more embodiments of the present disclosure;

FIG. 8A schematically depicts a pattern for a first etching mask for forming a plurality of regions in a diffractive surface region, according to one or more embodiments of the present disclosure;

FIG. 8B schematically depicts a pattern for a second etching mask for forming a plurality of regions in a diffractive surface region, according to one or more embodiments of the present disclosure;

FIG. 9 depicts a plurality of calculated far-field scattering patterns for a diffractive region formed using the first mask and the second mask depicted in FIGS. 8A and 8B, according to one or more embodiments of the present disclosure;

FIG. 10A depicts a histogram of surface heights in the diffractive surface region formed using the first mask and the second mask depicted in FIGS. 8A and 9B, according to one or more embodiments of the present disclosure;

FIG. 10B depicts a chart of calculated reflectance and haze performance of the diffractive region formed using the first mask and the second mask depicted in FIGS. 8A and 8B, according to one or more embodiments of the present disclosure;

FIG. 11A depicts a measured far-field scattering pattern associated with a first example article with a diffractive surface region, according to one or more embodiments of the present disclosure;

FIG. 11B depicts a chart of measured reflective intensity of the first example article, according to one or more embodiments of the present disclosure; and

FIG. 11C depicts a chart of azimuthally averaged scattering intensities for the first example article at a plurality of wavelengths, according to one or more embodiments of the present disclosure.

### DETAILED DESCRIPTION

Referring generally to the figures, described herein are display articles comprising diffractive regions that are designed to significantly reduce specular reflections throughout a wavelength range of interest while still providing relatively low scattering intensities at high scattering angles. Such diffractive surface regions beneficially prevent distinct reflected images from disrupting users' viewing experiences of the display, while still providing favorable image contrast characteristics. Such favorable performance is achieved by structuring a major surface of the display article to comprise a plurality of regions, with each of the regions comprising an area of the major surface that is disposed at a height relative to an imaginary base plane. The plurality of regions are structured such that the heights associated with the regions form a discrete distribution of heights. Differences between heights in the discrete distribution of heights are within 5% of integer multiples of λ̅/4, with λ̅ being defined by a range of angles of incidence (from θₘᵢₙ to θₘₐₓ) on the major surface over which specular reflectance is sought to be reduced and a wavelength range of interest (from λₘᵢₙ to λₘₐₓ), according to

$$\overline{λ} = {( \frac{{λ}_{min}^{′ - 1} + {λ}_{max}^{′ - 1}}{2} )}^{- 1} ,$$

with λ′ₘᵢₙ=λₘᵢₙ/cos θₘᵢₙ, and λ′ₘₐₓ=λₘₐₓ/cos θₘₐₓ. The plurality of regions are arranged in a pattern that is identified based on a target far-field scattering pattern associated with relatively low scattering amplitudes at scattering angles above 2°. It has been found that such a distribution of heights associated with the regions of the diffractive surface region, when so arranged, reduces specular reflectance by a least a factor of 10 (e.g., at least a factor of 100, at least a factor of 1000) as compared to an untextured article without the diffractive surface region, while providing favorable haze performance.

As used herein, the term “specular reflectance” refers to the percentage of light reflected from an article at an angle of reflection that is equivalent to an angle of incidence of the light.

As used, herein, the term “haze” or “transmission haze” refers to the percentage of transmitted light scattered outside an angular cone of about ±2.5° in accordance with ASTM D1003, entitled “Standard Test Method for Haze and Luminous Transmittance of Transparent Plastics,” the contents of which are incorporated by reference herein in their entirety. Note that although the title of ASTM D1003 refers to plastics, the standard has been applied to substrates comprising a glass material as well. For an optically smooth surface, transmission haze is generally close to zero.

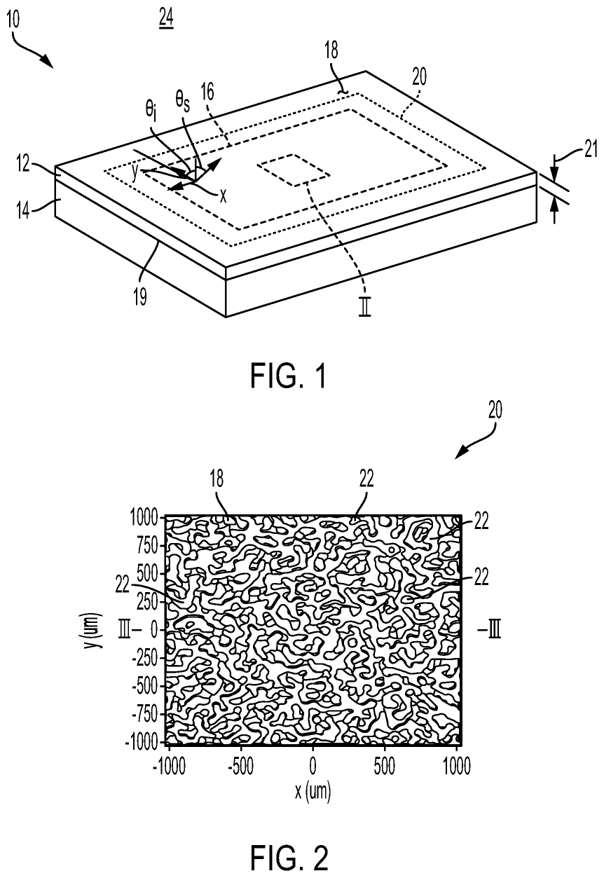

Referring now to FIG. 1, a display article 10 is depicted, according to an example embodiment. The display article 10 comprises a substrate 12. In embodiments, the display article 10 further includes a housing 14 to which the substrate 12 is coupled and a display 16 within the housing 14. In such embodiments, the substrate 12 at least partially covers the display 16 such that light that the display 16 emits can transmit through the substrate 12.

The substrate 12 includes a first major surface 18, a second major surface 19, a diffractive surface region 20 defined on the first major surface 18, and a thickness 21 that the first major surface 18 bounds in part (e.g., representing a minimum distance between the first major surface 18 and the second major surface 19 at a particular point on the first major surface 18). In the depicted embodiment, the substrate 12 is substantially planar is shape such that the first major surface 18 and the second major surface 19 are generally flat (with the exception of the first major surface 18 transitioning between heights, as described herein). Embodiments where the substrate 12 comprises a curved shape (e.g., via suitable hot-forming and cold-forming techniques) are also contemplated and within the scope of the present disclosure. The first major surface 18 generally faces toward an external environment 24 surrounding the display article 10 and away from the display 16. In embodiments, the display 16 emits visible light that transmits through the thickness 22 of the substrate 12, out the first major surface 18, and into the external environment 24.

The diffractive surface region 20 is structured to scatter light originating from the external environment 24 in a scattering pattern that is designed to suppress specular reflectance while also having relatively low scattering amplitudes at scattering angles (θₛ) greater than or equal to 2.0° (e.g., greater than or equal to 2.5°, greater than or equal to) 3.0°. In embodiments, the diffractive surface region 20 is structured to have a far-field scattering pattern with a maximum scattering amplitude at a scattering angle of less than or equal to 2.0° (e.g., less than or equal to 1.5°, less than or equal to 1.0°, less than or equal to 0.9°, less than or equal to 0.8°, less than or equal to 0.7°, less than or equal to 0.6°, less than or equal to) 0.5° throughout a wavelength range of interest [λₘᵢₙ, λₘₐₓ] over a range of angles of incidence (θᵢ). In embodiments, the diffractive surface region 20 is structured so as to reduce specular reflectance by at least 10 times (e.g., at least 100 times, at least 1000 times, at least 1000 times) relative to a smooth, untextured version of the first major surface 18. By reducing specular reflectance of the substrate 12, while controlling scattering amplitudes at relatively high scattering angles, the structure of the diffractive surface region 20 provides favorable anti-glare and haze performance as compared with certain existing display articles.

As used herein, the term “untextured version,” when used in describing specular reflectance performance of the articles described herein, refers to a specular reflectance predicted using the Fresnel Coefficients associated with an optically smooth surface of the material out of which the substrate 12 is constructed. For example, if the substrate 12 is constructed of a material (e.g., glass or suitable polymeric material) with a refractive index n₁ and the external environment comprises a refractive index n₂ (e.g., of air), the specular reflectance of the untextured version of the substrate 12 may be computed using the following equations:

$${R}_{s} = {\vert \frac{{n}_{1} cos {θ}_{i} - {n}_{2} cos {θ}_{t}}{{n}_{1} cos {θ}_{i} + {n}_{2} cos {θ}_{t}} \vert}^{2} \qquad ( 1 )$$

$${R}_{p} = {\vert \frac{{n}_{1} cos {θ}_{t} - {n}_{2} cos {θ}_{i}}{{n}_{1} cos {θ}_{t} + {n}_{2} cos {θ}_{i}} \vert}^{2} \qquad ( 2 )$$

where θᵢ is an angle of incidence on the first major surface 18, θₜ is the angle of transmission just after the first major surface (determined using Snell's law), Rₛ is the intensity reflectance for s-polarized light, and Rₚ is the intensity reflectance for p-polarized light. Unless otherwise noted, specular reflectance reduction performance values provided herein are averaged for polarization.

FIG. 2 schematically depicts a plane view of the region II of the diffractive surface region 20 of the display article 10 depicted in FIG. 1, according to an example embodiment of the present disclosure. In embodiments, within the diffractive surface region 20, the first major surface 18 comprises a non-uniform structure such that the first major surface 18 comprises surface height deviations measured relative to an imaginary base plane that are greater than a maximum surface roughness value (e.g., Sa value) of portions of the first major surface 18 extending within 2° of parallel to the second major surface 19. The first major surface 18 comprises surface height deviations outside of a range associated with an inherent roughness of the material out which the substrate 12 is formed. As a result of such surface height deviations, within the diffractive surface region 20, the first major surface 18 comprises a plurality of regions 22. Each of the plurality of regions 22 makes up a portion of the first major surface 18 and extends generally parallel to the second major surface 19, while it should be understood that each of the plurality of regions 22 may be slanted relative to the second major surface 19 as a result of the forming processes for the plurality of regions 22 described herein. In embodiments, each of the plurality of regions 22 represents a contiguous portion of the first major surface 18 that does not comprise a surface height deviation outside of a range associated with a surface roughness of the first major surface 18. Each of the plurality of regions 22 comprises a portion of the first major surface 18 that is disposed at a common height (e.g., within a tolerance associated with forming processes) relative to an imaginary base plane extending through the substrate 12. Each of the plurality of regions 22 is adjacent to at least one other one of the plurality of regions 22 comprising a portion of the first major surface 18 that is disposed at a different height relative to the imaginary base plane than that region. Ones of the plurality of regions 22 comprising the same height relative to the imaginary base plane may be separated from one another by at least one other one of the plurality of regions disposed at a different height relative to the imaginary base plane. Boundaries of each of the plurality of regions 22 are demarcated by contours where abrupt changes (e.g., greater than 50 nm) in surface height are observed on the first major surface 18.

As described herein, the plurality of regions 22 forming the diffractive surface region 20 are arranged in a predetermined pattern that is calculated based on a target far-field scattering pattern exhibiting low amplitudes of specular reflectance for light incident on the first major surface 18 from the external environment 24 and low scattering amplitudes at scattering angles greater than 2° (e.g., greater than 5°, greater than) 10°. The predetermined pattern is generally not discernable through observation via the naked eye, but rather identified using an optimization algorithm via the methods described herein. The plurality of regions 22 may vary substantially in size and shape over the diffractive surface region 20. For example, in embodiments, a maximum linear dimension (a length of a longest line segment connecting portions of the perimeter of a region to one another without intersecting another portion of the perimeter) of the plurality of regions 22 can vary from 10s of microns to 100s of microns.

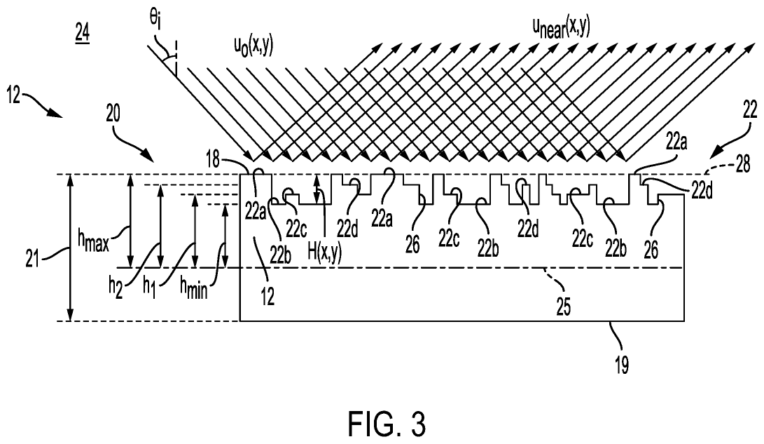

FIG. 3 schematically depicts a simplified cross-sectional view of the diffractive surface region 20 through the line III-III depicted in FIG. 2. The cross-sectional view depicted in FIG. 3 is conceptual and simplified for the purposes of discussion and does not correspond to the actual pattern depicted in FIG. 2. As shown in FIG. 3, the plurality of regions 22 comprise portions of the first major surface 18 that are disposed at a discrete distribution of heights measured relative to an imaginary base plane 25 extending through the substrate 12 and parallel to the first major surface 18 (with each region comprising a section of the first major surface 18 extending generally parallel to the imaginary base plane 25, allowing for manufacturing tolerances). In embodiments, the plurality of regions 22 comprises a first plurality of regions 22a where the first major surface 18 is disposed at a maximum height hₘₐₓ measured as a distance in a direction perpendicular to the imaginary base plane 25 and a second plurality of regions 22b where the first major surface 18 is disposed at a minimum height hₘᵢₙ measured as a distance in the direction perpendicular to the imaginary base plane 25. The imaginary base plane 25 is not a physical component of the substrate 12, but rather an imaginary reference plane extending through the substrate 12. In embodiments, the imaginary base plane 25 extends through a geometric center of the substrate 12. In the depicted embodiment, the first plurality of regions 22a of the first major surface 18 represent points on the first major surface 18 that are disposed a maximum distance from the imaginary base plane 25, such that the thickness 21 has a maximum value when measured within the first plurality of regions 22a. The precise heights that the each of the first plurality of regions 22a may deviate slightly from hₘₐₓ. In embodiments, hₘₐₓ represents an average measured height of the first plurality of regions 22a and the heights of each of the first plurality of regions 22a is within 5% of hₘₐₓ. The same goes for other heights in the discrete distribution of heights.

In embodiments, the discrete distribution of heights at which the first major surface 18 is disposed relative to the imaginary base plane 25 may include any number of heights (e.g., 2 heights, 3, heights, 4 heights, 5 heights, 6 heights, 7 heights, 8 heights, 9 heights, 10 heights, or an even greater number of heights). In embodiments, the plurality of regions 22 comprises a third plurality of regions 22c where the first major surface 18 is disposed at a height h₁ relative to the imaginary base plane 25 and a fourth plurality of regions 22d where the first major surface 18 is disposed at a height h₂ relative to the imaginary base plane 25. The heights in the discrete distribution of heights are evenly spaced, such that differences between adjacent heights are within 5% of a spacing constant (e.g., hₘₐₓ−h₂=h₂−h₁=h₁−hₘᵢₙ). The heights in the discrete distribution of heights may differ from one another by integer multiples of the spacing constant. The value for the spacing constant is described in greater detail herein that may be used to achieve favorable anti-glare and haze performance attributes.

As shown in FIG. 3, the plurality of regions 22 of the first major surface 18 are separated from one another by transition surfaces 26 of the substrate 12. The transition surfaces 26 represent segments of an exterior surface of the substrate 12 that extend at a substantial angle (e.g., greater than) 20° relative to the imaginary base plane 25. The transition surfaces 26 represent points where a surface height of the first major surface 18 deviates outside of a range associated with a surface roughness of the first major surface 18. The length of each of the transition surfaces 26 depends on the pattern of the plurality of regions 22 (i.e., which heights in the discrete distribution of heights are disposed adjacent to one another). In embodiments, at least some of the transition surfaces 26 extend perpendicular (or within 10° of perpendicular) to the imaginary base plane 25. Such transition surfaces 26 that extend perpendicular to the imaginary base plane 25 may have lengths corresponding to differences between heights of the discrete distribution of heights (e.g., hₘₐₓ−hₘᵢₙ, hₘₐₓ−h₂, hₘₐₓ−h₁).

As will be appreciated, each region in the first plurality of regions 22a may be disposed at a height that differs slightly from hₘₐₓ, each region in the second plurality of regions 22 may be disposed at a height that differs slightly from hₘᵢₙ, each region in the third plurality of regions 22c may be disposed at a height that differs slightly from h₁, and each region in the fourth plurality of regions 22d may be disposed at a height that differs slightly from h₂ due to manufacturing tolerances. As such, the heights hₘₐₓ, hₘᵢₙ, h₁, and h₂ may represent manufacturing targets for forming the diffractive surface region 20 using any of the methods described herein. In embodiments, each region of the first plurality of regions 22a, the second plurality of regions 22b, the third plurality of regions 22c, and the fourth plurality of regions 22d is disposed at a height that is within 5% of its target value. In embodiments, if an average surface height for each region of the first plurality of regions 22a, the second plurality of regions 22b, the third plurality of regions 22c, and the fourth plurality of regions 22d is measured, and each set of average values associated with each height in the discrete distribution of heights is averaged, the averaged value of each set may be within 5% of the manufacturing target value. In embodiments, such averaged values of each set may differ from one another by within 5% an integer multiple of the spacing constant establishing the spacing of the heights described herein.

In embodiments, a combined surface area of each of the plurality of regions 22 at each height in the discrete distribution of heights occupies a predetermined combined surface area percentage of the diffractive surface region 20. In the depicted example, the first plurality of regions 22a occupies a first combined surface area percentage of the diffractive surface region 20, the second plurality of regions 22b occupies a second combined surface area percentage of the diffractive surface region 20, the third plurality of regions 22c occupies a third combined surface area percentage of the diffractive surface region 20, and the fourth plurality of regions 22d occupies a fourth combined surface percentage of the diffractive surface region 20. In embodiments, the first combined surface area percentage is within 5% of the second combined surface area percentage and the third combined surface area percentage is within 5% of the fourth combined surface area percentage. In embodiments, the second combined surface area percentage and the third combined surface area percentage are greater than the first combined surface area percentage or the second combined surface area percentage. In embodiments, each of the first, second, third, and fourth combined surface area percentages is less than 40%.

The pattern in which the plurality of regions 22 are arranged, as well as the combined surface area percentage associated with each height in the discrete distribution of heights may be determined using scalar diffraction theory and a suitable optimization algorithm, as described herein. As shown in FIG. 3, incoming radiation from the external environment 24 may be approximated as uniform planewave approximated as

$${u}_{0} ( x , y ) = \sqrt{{I}_{0}} {e}^{i ( {k}_{x 0} x + {k}_{y 0} y )} \qquad ( 3 )$$

where Iₒ represents a uniform intensity of incoming radiation and kₓₒ and k_{yo} represent wave vectors associated with the wavelength of the radiation and the angle of incidence on the first major surface 18 (e.g., the angle of incidence may be broken up into components in the x and y directions, as shown in FIG. 1). In such a case, the scalar near field for the outgoing radiation (after interaction with the first major surface 18) can be approximated as

$${u}_{near} ( x , y ) = ρ {u}_{0} ( x , y ) \cdot {e}^{i ϕ ( x , y )} \qquad ( 4 )$$

where ρ is the Fresnel coefficient of the interface (computed using Equation 1 or Equation 2, depending on the polarization of the incoming radiation), and

$$ϕ ( x , y ) = \frac{2 π}{λ} 2 H ( x , y )$$

is the local phase accumulated through the double passage of the distance to the first major surface 18, H(x, y), with H(x,y) representing the pattern in which the plurality of regions 22 are arranged (H(x,y) represents the distribution of heights as measured from an imaginary plane 28 extending at the height hₘₐₓ and parallel to the imaginary base plane 25, but is related to the heights hₘₐₓ, hₘᵢₙ, h₁, and h₂). In this example, incoming radiation is approximated as having a uniform intensity distribution and the interface between the substrate 12 and the external environment 24 is approximated as only applying a spatially varying phase such that the outgoing radiation in the near field also has a uniform intensity distribution.

In this example depicted in FIG. 3, the far field scattering pattern associated with the outgoing radiation may be represented in the reciprocal k space and is related to the near field uₙₑₐᵣ(x, y) computed using Equation 4 through a Fourier transform and expressed as

$${u}_{far} ( {k}_{x} , {k}_{γ} ) = [ {u}_{near} ( x , y ) ] = \int \int dxdy {e}^{- i ( {k}_{x} x + {k}_{y} y )} {u}_{near} ( x , y ) \qquad ( 5 )$$

In embodiments, the pattern in which the plurality of regions 22 is arranged is selected so that H(x,y), when input into Equation 5, substantially matches a target far field distribution. In embodiments, the target far field distribution is selected to provide relatively low levels of specular reflection and low scattering amplitudes at angles greater than 2.0°. One set of target far field distributions may be mathematically described by the Laguerre-Gaussian (“LG”) modes, expressed as

$${u}_{l} ( k ) = {{c}_{l} ( \frac{k}{{k}_{max}} )}^{l} exp ( - \frac{l}{2} \frac{{k}^{2}}{{k}_{max}^{2}} ) , \qquad ( 6 )$$

where l is an azimuthal index, kₘₐₓ is a wavenumber associated with a maximum scattering intensity, and ci is a normalization factor. The LG modes beneficially provide an (l−1^{th}) order zero at wavenumbers equal to 0 (representing specular reflection), with greater l values being associated with a flatter distribution of scattering amplitudes around specular reflectance. The LG modes also beneficially decay exponentially at large wavenumbers (associated with large angles of scattering).

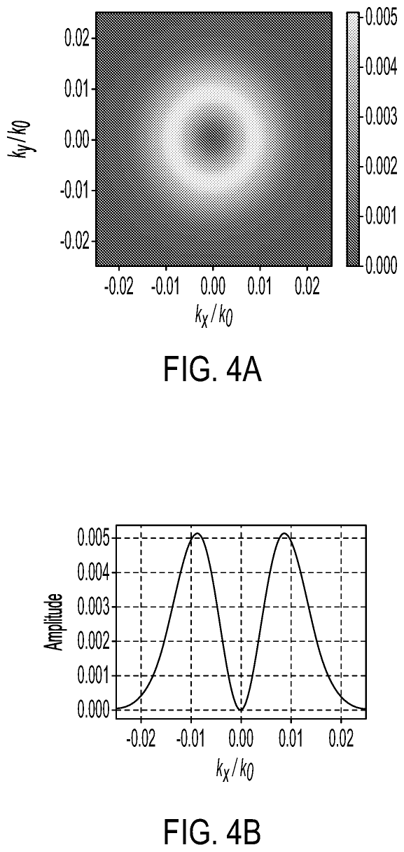

An example LG mode scattering distribution, with the azimuthal index l equal to 2, is depicted in FIGS. 4A and 4B. FIG. 4A depicts the two-dimensional scattering function, while FIG. 4B depicts a graph view of the scattering amplitudes through the line k_{y}/kₒ=0 (representing scattering amplitudes when the incoming radiation is incident at varying angles of incidence in a single plane of incidence). As shown, the scattering pattern provides very low specular reflection, with scattering maxima appearing at kₓ/kₒ=0.008, corresponding to a maximum scattering angle of 0.5 degrees. While the LG modes are one potential target far field scattering distribution, it should be appreciated that a variety of target far field scattering distributions are contemplated and within the scope of the present disclosure. The target far field scattering distribution may be used in a suitable optimization algorithm to determine the pattern for the plurality of regions 22, as described herein.

In embodiments, the objective to reduce specular reflection occurs over a wavelength range of interest of wavelengths greater than or equal to a minimum wavelength of interest λₘᵢₙ and less than or equal to a maximum wavelength range of interest λₘₐₓ. λₘᵢₙ and λₘₐₓ may vary depending on the application. For example, an objective in one application may be to minimize specular reflectance over from the visible to the near infrared, such that λₘᵢₙ=380 nm and λₘₐₓ=1200 nm. In another example, it may only be desired to limit specular reflectance over the visible spectrum, such that λₘᵢₙ=380 nm and λₘₐₓ=730 nm. Any suitable wavelength range of interest may be used.

In embodiments, the objective to reduce specular reflection occurs over a variety of angles of incidence θᵢ (see FIG. 3). That is, for a particular display application, it may be advantageous to provide anti-glare functionality over a wide range of angles of incidence θᵢ to prevent reflected images from being noticeable to users from a variety of different angles. In embodiments, for example, it may be desired to minimize specular reflection at angles of incidence ranging from θₘᵢₙ to θₘₐₓ. In embodiments, θₘᵢₙ=0°, 5°, 10° or 20°. In embodiments, θₘₐₓ=70°, 60°, 50°, 45°, 40°, 35°, or 30°. In view of the foregoing, the objective to reduce specular reflectance may be understood as minimizing specular reflection over a wavelength range of interest of [λₘᵢₙ, λₘₐₓ] at a plurality of angles of incidence within the range [θₘᵢₙ, θₘₐₓ] (with square brackets indicating the boundaries of the ranges being included). Such a problem may be simplified in reciprocal k-space as minimizing specular reflection for wavevectors k between k′ₘᵢₙ and k′ₘₐₓ. That is, the objective to minimize specular reflectance may be understood as minimizing specular reflectance between k′ₘᵢₙ and k′ₘₐₓ, where

$${k}_{min}^{′} = \frac{2 π * cos {θ}_{min}}{{λ}_{min}} and {k}_{max}^{′} = \frac{2 π * cos {θ}_{max}}{{λ}_{max}} .$$

With reference to FIG. 3, the combined surface area percentage for each height hᵢ in the distribution of heights of the plurality of regions 22 can be expressed as a value Aⱼ, with j denoting a reference integer. One can also provide the constraint that Σⱼ₌₁^{N}Aⱼ=1, such that the plurality of regions 22 occupies 100% of the surface area of the first major surface 18 in the diffractive surface region 20. In such cases, and in view of Equations 3-5, it can be established that the object to minimize specular reflectance can be mathematically expressed as minimizing a function proportional to ƒ(A, h), expressed as

$$f ( A , h ) ≡ {\int }_{{k}_{min}^{′}}^{{k}_{max}^{′}} dk \cdot g ( k ) {\vert {\sum }_{j = 1}^{N} {A}_{j} \cdot {e}^{i k 2 {h}_{j}} \vert}^{2} \qquad ( 7 )$$

where Aⱼ and hⱼ are free parameters in the optimization and g(k) is a spectral weight function. In embodiments g(k)=k⁻¹ such that g(k)dk=d(log(k)), corresponding to sampling k uniformly in the logarithmic scale throughout the wavelength range of interest [λₘᵢₙ, λₘₐₓ] and range of angles of incidence [θₘᵢₙ, θₘₐₓ]. In such a case, under the constraint that Σⱼ₌₁^{N}Aⱼ=1, it can be shown that Equation 7 has an analytic solution

$${h}_{j} = {h}_{0} + j \overline{\frac{λ}{4}} \qquad ( 8 )$$

where h₀ is a constant and A is the harmonic mean of λ′ₘᵢₙ and λ′ₘₐₓ, expressed as

$$\overline{λ} = {( \frac{{λ}_{min}^{′ - 1} + {λ}_{max}^{′ - 1}}{2} )}^{- 1} \qquad ( 9 )$$

where λ′ₘᵢₙ=λₘᵢₙ/cos θₘᵢₙ, and λₘₐₓ=λₘₐₓ/cos θₘₐₓ. Accordingly, in embodiments, as described above with respect to FIG. 3, differences between heights in the discrete distribution of heights of the plurality of regions 22 in the diffractive surface region 20 are ideally integer multiples λ̅/4. Manufacturing methods used to form the plurality of regions 22 may result in the actual heights of the plurality of regions differing slightly from those computed using Equations 8-9. As such, differences between the heights in the discrete distribution of heights may differ from one another by within 5% of integer multiples of λ̅/4. Accordingly, in the example depicted in FIG. 3, h₁=hₘᵢₙ+λ̅/4, h₂=hₘᵢₙ+λ̅/2, and hₘₐₓ=hₘᵢₙ+3λ̅/4.

With reference to Equations 7-9, the ideal combined surface area percentage Aⱼ associated with each height hⱼ satisfies a linear set of equations, expressed by the following matrix equation

$$FA = 1 \qquad ( 10 )$$

Where A is a vector of the ideal areas Aⱼ, 1 is the unity column vector having N elements (with N corresponding to the number of heights in the discrete distribution of heights), and F is an N×N matrix, with each element in F being computed as

$${F}_{ij} = {\int }_{{k}_{min}^{′}}^{{k}_{max}^{′}} \frac{dk}{k} cos ( k \cdot \frac{\overline{λ} ( i - j )}{2} ) . \qquad ( 11 )$$

Using Equations 10-11 to compute the ideal combined surface area percentage Aⱼ for each height hⱼ computed using equation (9), one can compute an optimal local phase accumulation function

$$ϕ ( x , y ) = \frac{2 π}{λ} 2 H ( x , y )$$

that minimizes specular reflection (determined using Equations 4 and 5) for wavelength range of interest [λₘᵢₙ, λₘₐₓ] and range of angles of incidence [θₘᵢₙ, θₘₐₓ], for various values of λₘᵢₙ, λₘₐₓ, θₘᵢₙ, and θₘₐₓ. In an example where λₘᵢₙ=400 nm, λₘₐₓ=800 nm, θₘᵢₙ=0°, and θₘₐₓ=60°, the values for λ′ₘᵢₙ, λ′ₘₐₓ may be computed and plugged into Equation 9 to compute a value of λ̅/4-150 nm. Using this value of λ̅ in Equation 11, and area vector A can be computed as (0.178, 0.322, 0.322, 0.178), with the first value corresponding to the combined area percentage at λₘᵢₙ, the second and third values being at the heights h₁ and h₂, respectively, and the fourth value being at the height hₘₐₓ.

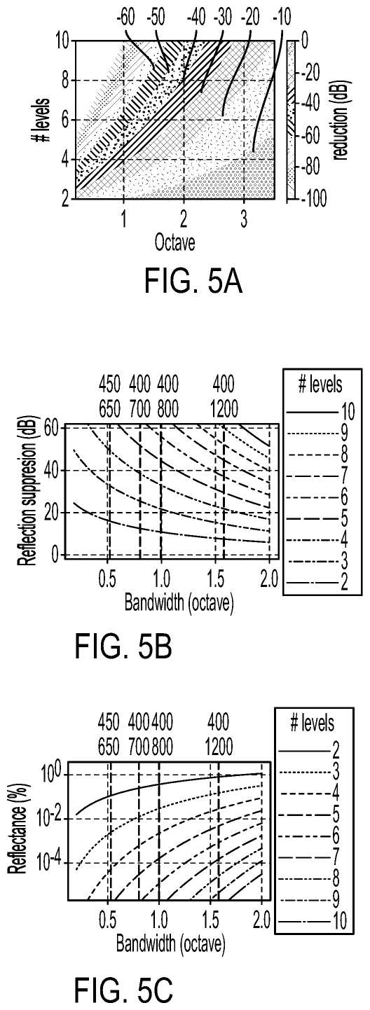

FIGS. 5A, 5B, and 5C depict computed ideal specular reflection and reduction (as compared to an untextured version of the first major surface 18) for a plurality of distributions of heights for the plurality of regions 22 (with each distribution containing a different number of heights) for a plurality of different wavelength ranges of interest (expressed in units of octaves=log₂(λₘₐₓ/λₘᵢₙ)). As shown in FIG. 5B, for a wavelength range of interest of 400 nm to 800 nm (corresponding to 1 octave), two discrete heights reduces specular reflection by about 10 dB as compared to the untextured version, whereas four discrete heights reduces specular reflection by about 30 dB. As shown in FIG. 5C, over the wavelength range of interest of 400 nm to 800 nm, two discrete heights provides a specular reflectance of just under 1%, whereas four discrete heights provides a specular reflectance of under 0.01%. The results of this analysis are summarized in the Table 1 below, which provides the specular reflection reduction (in dB) as compared to an untextured version of the first major surface 18 for various wavelength ranges of interest (with the values representing average reductions over the wavelength range of interest).

TABLE 1

| | Bandwidth | | | | | | | | | |
|---|---|---|---|---|---|---|---|---|---|---|
| | (octave) | | | | | | | | | |
| # levels | 0.2 | 0.4 | 0.6 | 0.8 | 1.0 | 1.2 | 1.4 | 1.6 | 1.8 | 2.0 |
| 2 | 24.1 | 18.1 | 14.7 | 12.3 | 10.5 | 9.1 | 8.0 | 7.0 | 6.3 | 5.6 |
| 3 | 49.1 | 37.1 | 30.1 | 25.3 | 21.6 | 18.6 | 16.2 | 14.2 | 12.5 | 11.1 |
| 4 | 74.2 | 56.2 | 45.8 | 38.4 | 32.8 | 28.4 | 24.7 | 21.6 | 18.9 | 16.7 |
| 5 | 99.4 | 75.4 | 61.5 | 51.7 | 44.2 | 38.2 | 33.2 | 29.0 | 25.5 | 22.4 |
| 6 | 124.7 | 94.7 | 77.2 | 65.0 | 55.6 | 48.1 | 41.8 | 36.6 | 32.1 | 28.2 |
| 7 | 149.9 | 113.9 | 93.0 | 78.3 | 67.0 | 57.9 | 50.4 | 44.1 | 38.7 | 34.0 |
| 8 | 175.2 | 133.2 | 108.8 | 91.6 | 78.4 | 67.8 | 59.1 | 51.6 | 45.3 | 39.8 |

The Table 1 may provide guidance to determine the number of levels that may be needed for a particular application, depending on a level of specular reflectance reduction that is needed and applicable wavelength range of interest. Generally, greater bandwidths associated with the wavelength range of interest increases the number of levels necessary to achieve a particular reflectance reduction with respect to that from the untextured surface.

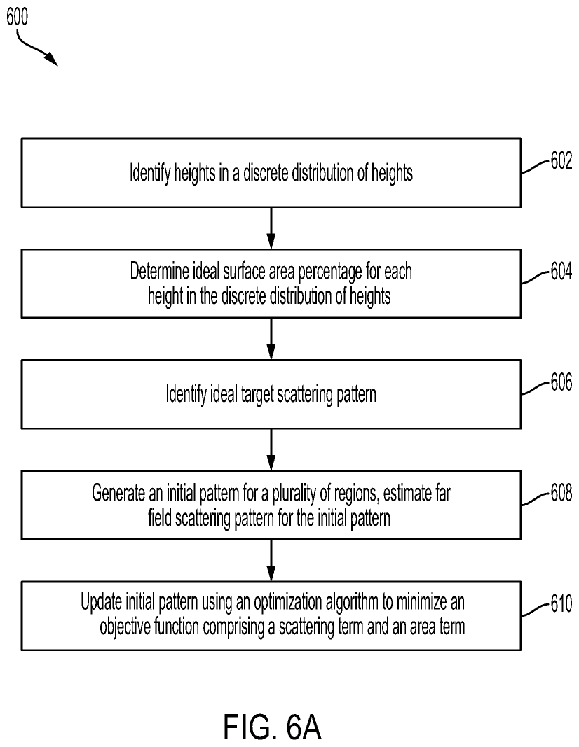

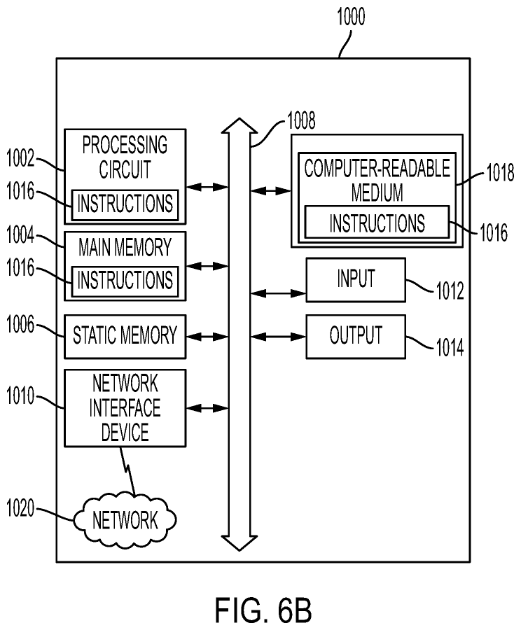

FIG. 6A depicts a flow diagram of a method 600 of determining a pattern for a plurality of regions of a diffractive surface region, according to an example embodiment of the present disclosure. The method 600 may be performed on the computer system 1000 depicted in FIG. 6B.

In embodiments, the computer system 1000 comprises a processing circuit or processor 1002, a main memory 1004 (e.g., read-only memory (ROM), flash memory, dynamic random-access memory (DRAM), such as synchronous DRAM (SDRAM), etc.), and a static memory 1006 (e.g., flash memory, static random-access memory (SRAM), etc.), which may communicate with each other via a data bus 1008. Alternatively, the processor 1002 may be connected to the main memory 1004 and/or the static memory 1006 directly or via some other connectivity means. The computer system 1000 may further comprise include a network interface device 1010. The computer system 1000 may also include an input 1012, configured to receive input and selections to be communicated to the computer system 1000 when executing instructions. The computer system 1000 also may also comprise an output 1014, including, but not limited to, a display, a video display unit (e.g., a liquid crystal display (LCD) or a cathode ray tube (CRT)), an alphanumeric input device (e.g., a keyboard), and/or a cursor control device (e.g., a mouse). The computer system 1000 may also comprise instructions 1016 stored in a computer-readable medium 1018 and/or reside within the main memory 1004 and/or within the processor 1002 during execution thereof by the computer system 1000, the main memory 1004 and the processor 1002 also constituting computer-readable medium. The instructions 1016 may further be transmitted or received over a network 1020 via the network interface device 1010. A user may perform the method 600 using the computer system by providing inputs via the input 1010 and causing execution of the following processes steps encoded in the instructions 1016 via the processor 1002.

In embodiments, the method 600 may be used to design various display articles. For example, the method 600 may be used to design the diffractive surface region 20 of the display article 10 described herein with respect to FIGS. 1-3. Accordingly, reference to various features depicted in FIGS. 1-3 will be made to aid in describing the method 600, with the understanding that the method may be used to design other display articles.

With reference to FIG. 6A, at block 602, a discrete distribution of heights for the diffractive surface region 20 is identified. In embodiments, for example, a user may identify a suitable wavelength range of interest [λₘᵢₙ, λₘₐₓ] and range of angles of incidence [θₘᵢₙ, θₘₐₓ] over which specular reflectance is sought to be minimized. Such values may vary depending on the application. For example, a display article 10 implemented in a television or computer monitor may seek to reduce specular reflectance over a different range of angles of incidence than a display article 10 implemented in an automotive interior display. Once the wavelength range of interest [λₘᵢₙ, λₘₐₓ] and the range of angles of incidence [θₘᵢₙ, θₘₐₓ] are identified and input into the computer system 1000 (e.g., via the input 1012), the computer system 1000 may execute instructions 1016 that compute a plurality of plots such as those depicted herein in FIGS. 5A-5C, thereby indicating the extent that specular reflectance may be reduced for various distributions of heights given the wavelength range of interest [λₘᵢₙ, λₘₐₓ] and the range of angles of incidence [θₘᵢₙ, θₘₐₓ]. In embodiments, the user may select a number of heights based on the indicated specular reflection reduction performance. In embodiments, the instructions 1016 cause the processor 1002 to automatically select a number of levels based on specular reflectance performance requirements input by the user (e.g., the user may indicate a maximum allowable specular reflectance). The heights in the discrete distribution of heights are determined via the equations (7)-(9) described herein.

At block 604, an ideal surface area percentage for each height in the discrete distribution of heights is identified. The ideal surface area percentages may be computed via Equations 10 and 11 described herein. At block 606, an ideal target scattering pattern is identified. In embodiments, the user may select an ideal target scattering pattern ũ(λ) that may vary depending on the application. As an example, the user may define a suitable LG mode by defining an appropriate azimuthal index l and kₘₐₓ parameter, described herein with respect to Equation 6. Other suitable ideal scattering patterns may be used.

At block 608, an initial pattern for the plurality of regions 22 is generated. In embodiments, the instructions 1016 initiate an optimization algorithm by inputting a pre-stored initial pattern. It has been determined that the initial pattern does not have a great effect on the final results of the optimization, so any suitable random pattern for the plurality of regions 22 may be used. Once the initial pattern is generated, the instructions 1016 may cause the processor 1002 to estimate a far field scattering pattern u(λ) for the initial pattern. For example, the initial pattern may be used to define local phase accumulation function

$$ϕ ( x , y ) = \frac{2 π}{λ} 2 H ( x , y )$$

in Equations 4 and 5 and compute the estimated far field scattering pattern u(λ).

At block 610, the initial pattern is updated using an optimization algorithm to minimize a suitable objective function. As described herein, the discrete distribution of heights and the ideal surface area percentage associated with each height may be determined based on the objective to minimize or reduce specular reflectance over the wavelength range of interest [λₘᵢₙ, λₘₐₓ] and the range of angles of incidence [θₘᵢₙ, θₘₐₓ]. An objective to provide relatively low scattering amplitudes at high scattering angles (e.g., greater than or equal to 2.0°, greater than or equal to 2.5°, greater than or equal to 3.0°, greater than or equal to 3.5°, greater than or equal to 4.0°, greater than or equal to 4.5°, greater than or equal to 5.0°, or even greater angles) may be incorporated via comparing the estimated far field scattering pattern u(λ) to the ideal target scattering pattern ũ(λ). Accordingly, the objective function may incorporate a scattering term that compares the estimated far field scattering pattern u(λ) to the ideal target scattering pattern ũ(λ), as well as an area term, which compares actual combined surface area percentages associated with each height in the initial pattern to the ideal values Aⱼ computed herein using Equations 10-11.

In embodiments, a suitable objective function may be expressed as

$$F ( P ) = \frac{1}{K} {\sum }_{k = 1}^{K} log ( \vert {\sum }_{( i j )} {\tilde{u}}_{i j}^{*} ( {λ}_{k} ) \cdot {u}_{ij} ( {λ}_{k} ) \vert ) + w * {\sum }_{i = 1}^{N} {( {A}_{i} - {Ã}_{i} )}^{2} \qquad ( 12 )$$

where K is an integer value sampling the wavelength range of interest [λ′ₘᵢₙ, λ′ₘₐₓ] (e.g., the wavelength range of interest [λₘᵢₙ, λₘₐₓ] may be discretized uniformly using values for the integer K), i and j are integer values uniformly sampling a range of scattering angles, w is an area weighting factor (determining the weight to put on the pattern approximating the ideal combined surface area percentages computed using Equations 10-11), Aᵢ is the combined surface area percentage of one of the heights in the discrete distribution of heights associated with the initial pattern, and \tilde{λ}ᵢ is the ideal combined surface area percentage associated with that height. It has been found that the value of w may vary depending on the particular applications. A value for w of around 10 approximately corresponds to an equal weighting of the terms in Equation 12 and has been found to be a good starting point.

The initial pattern may be updated using a suitable nonlinear function optimization algorithm, in which values for the objective function in each iteration are compared with one another such that the initial pattern is updated via a plurality of iterations on a convergent solution which minimizes the objective function, such that the estimated far field scattering pattern u(λ) approximates that the ideal target far field scattering pattern ũ(λ) and the combined surface area percentage associated with each height in the discrete distribution of heights approximates the ideal value computed using Equations 10-11. Any suitable optimization algorithm may be used. Some examples are the Newton Conjugate Gradient (Newton-CG), the Broyden-Fletcher-Goldfarb-Shanno (BFGS) algorithm, and Sequential Least Squares Programming (SLSQP).

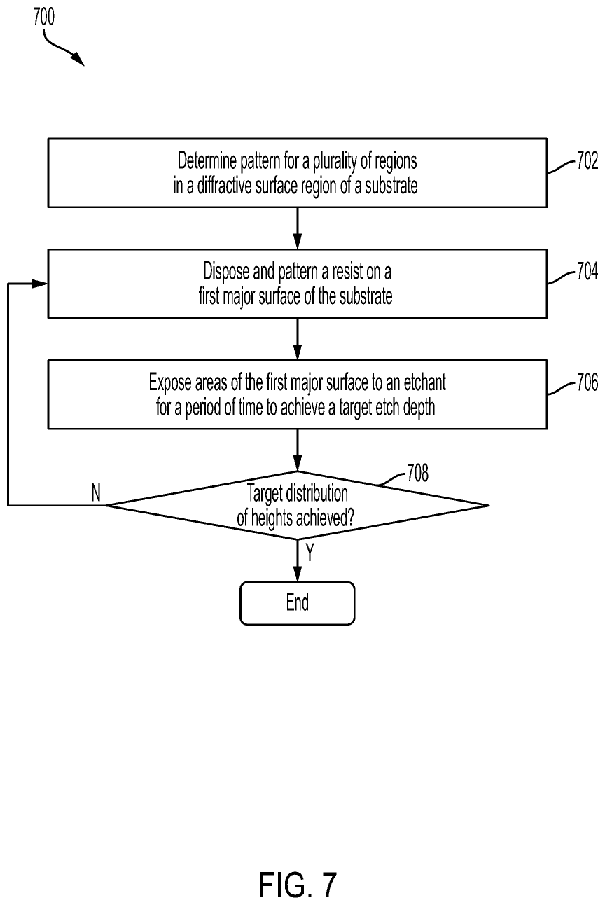

Referring again to FIGS. 1-3, the plurality of regions 22 in the first major surface 18 may be formed using any suitable technique. FIG. 7 depicts a flow diagram of an example method 700 of fabricating the display article 10, according to an example embodiment of the present disclosure. Reference to various components depicted in FIGS. 1-3 will be made to aid in describing the method 700. It should be understood that the particular method used to form diffractive surface region 20 is not particularly limiting and that any suitable method may be used.

At block 702, the pattern for the plurality of regions 22 is determined. In embodiments, the patterned is determined via the method 600 described herein with respect to FIG. 6A. At block 704 a resist is disposed on the first major surface 18 and patterned. The nature of the deposition and patterning of the resist may vary depending on the fabrication technique used. In embodiments, various nanoimprint or photolithographic techniques may be used to deposit and pattern the resist layer. In such embodiments, a minimum feature size (e.g., minimum linear dimension) associated with the plurality of regions 22 may be set to at least 1 μm (e.g. greater than or equal to 1.5 μm, greater than or equal to 2.0 μm, greater than or equal to 2.5 μm, greater than or equal to 5.0 μm, greater than or equal to 10 μm) to facilitate use of existing resist application and patterning techniques. In embodiments, for example, the resist may be formed using thermoplastic nanoimprint lithography, and the resist may be formed of a thermoplastic polymer that is spin-coated onto the substrate 12 and subsequently imprinted via a mold to form a first pattern that at least partially corresponds to the pattern for the plurality of regions 22 on the first major surface 18. The resist may be subsequently thermally cured to form an etching mask. Other methods of forming the resist (e.g., Gravure offset printing, other printing techniques) are also contemplated and within the scope of the present disclosure.

Photolithography (e.g., photo imprint nanolithography, optical photolithography) techniques may also be used, and the resist may be deposited onto the first major surface 18 via a suitable application method (e.g., spin coating). In such embodiments, a mask comprising a first pattern at least partially corresponding to the pattern determined for the plurality of regions 22 is aligned with the first major surface 18, and the resist may be exposed to radiation from a suitable light source (e.g., UV radiation) to cause the resist to cure and form an etching mask. The resist may subsequently be developed such that portions of the first major surface 18 are left exposed through the cured resist. Any suitable photolithographic technique may be used to pattern the resist. In embodiments, the pattern formed in the resist may be such that areas of the first major surface 18 that are covered by the resist form at least some of the first plurality of regions 22a, disposed at the height hₘₐₓ, described with respect to FIG. 3.

At block 706, exposed areas of the first major surface 18 (through the cured and patterned resist) are exposed to a suitable etchant for a suitable etchant period determined based on a target etch depth. Each area of the first major surface 18 that is exposed through the patterned resist formed in the block 704 may directly contact the etchant, which may degrade the substrate and remove material therefrom to form regions on the first major surface 18 that are disposed at a diminished height relative to the imaginary base plane 25 as compared to areas of the first major surface 18 that are covered by the patterned resist. In embodiments, the etchant that contacts the first major surface 18 is an HF/HNO₃ etchant. In embodiments, the etchant consists of hydrofluoric acid (HF, 49 w/w %) and nitric acid (HNO₃, 69 w/w %) combinations with 0.1-5 v/v % HF and 0.1-5 v/v % HNO₃. Typical concentrations used to achieve the etching depths discussed herein are 0.1 v/v % HF/1 v/v % HNO₃ to 0.5 v/v % HF/1 v/v % HNO₃ solutions. In embodiments, the etching can be carried out using a dip or spray etching process from room temperature to about 45° C.

At decision block 708, it is determined whether the target distribution of heights is achieved. As may be appreciated, it may be desirable that the plurality of regions 22 are disposed at more than 2 heights relative to the imaginary base plane 25. In embodiments, forming the diffractive surface region 20 with regions disposed more than 2 heights relative to the imaginary base plane 25 may include multiple etching steps with different etching masks and different etching periods. For example, in embodiments, an initial etching step is carried out with an initial etching mask and an initial etching period that is determined to etch portions of the first major surface 18 to depths of λ̅/2. After such an etching step (and additional steps such as cleaning), a second resist may be disposed and patterned on the first major surface 18 for etching for a second etching period. The second resist may leave portions of the first major surface 18 exposed that were already etched in the initial etching step. The second resist may also leave portions of the first major surface 18 exposed that were not etched in the initial etching step (due to coverage by the initial etching mask). The second etching period may be determined to achieve an etching depth of λ̅/4. Thus, as a result, the areas of the first major surface 18 that contact the etchant in both etching steps may be etched to a total height 3λ̅/4, areas only contacting the etchant in the first etching step may only be etched to a height of λ̅/2, areas contacting the etchant in only the second etching step may only be etched to a height of λ̅/4, and areas of the first major surface 18 that were covered by a resist in both the first and second etching steps may be unmodified. Such an example provides one way of achieving four discrete heights in the first major surface 18. Any suitable combination of etching steps may be used and a variety of different sequences are contemplated and within the scope of the present disclosure.

The resists disposed and patterned on the first major surface 18 during the method 700 may thus not (individually) exactly correspond with the desired final pattern for the plurality of regions. Instead, the pattern associated with each resist may be an intermediate pattern that is designed to form the final pattern determined via the method 600 described herein in combination with the patterns of any other etching masks that may be formed on the substrate 12. The blocks 704, 706, and 708 may be repeated until a desired number of heights in the discrete distribution of heights is achieved in the desired pattern, at which point the method 700 may end or additional processing steps (e.g., chemical strengthening) may be performed on the substrate 12.

### Substrate Properties

Various properties of the substrate 12 will now be described, according to embodiments of the present disclosure.

In embodiments, the substrate 12 is a glass substrate or a glass-ceramic substrate. In embodiments, the substrate 12 is a multi-component glass composition having about 40 mol % to 80 mol % silica and a balance of one or more other constituents, e.g., alumina, calcium oxide, sodium oxide, boron oxide, etc. In some implementations, the bulk composition of the substrate 12 is selected from the group consisting of aluminosilicate glass, a borosilicate glass, and a phosphosilicate glass. In other implementations, the bulk composition of the substrate 12 is selected from the group consisting of aluminosilicate glass, a borosilicate glass, a phosphosilicate glass, a soda lime glass, an alkali aluminosilicate glass, and an alkali aluminoborosilicate glass. In further implementations, the substrate 12 is a glass-based substrate, including, but not limited to, glass-ceramic materials that comprise a glass component at about 90% or greater by weight and a ceramic component. In other implementations of the display article 10, the substrate 12 can be a polymer material, with durability and mechanical properties suitable for the development and retention of the diffractive surface region 20.

In embodiments, the substrate 12 has a bulk composition that comprises an alkali aluminosilicate glass that comprises alumina, at least one alkali metal and, in some embodiments, greater than 50 mol % SiO₂, in other embodiments, at least 58 mol % SiO₂, and in still other embodiments, at least 60 mol % SiO₂, wherein the ratio (Al₂θ₃ (mol %)+B₂O₃ (mol %))/Σalkali metal modifiers (mol %)>1, where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio (Al₂θ₃ (mol %)+B₂O₃ (mol %))/Σalkali metal modifiers (mol %)>1, where the modifiers are alkali metal oxides.

In embodiments, the substrate 12 has a bulk composition that comprises an alkali aluminosilicate glass comprising, consisting essentially of, or consisting of: about 61 mol % to about 75 mol % SiO₂; about 7 mol % to about 15 mol % Al₂O₃; 0 mol % to about 12 mol % B₂O₃; about 9 mol % to about 21 mol % Na₂O; 0 mol % to about 4 mol % K₂O; 0 mol % to about 7 mol % MgO; and 0 mol % to about 3 mol % CaO.

In embodiments, the substrate 12 has a bulk composition that comprises an alkali aluminosilicate glass comprising, consisting essentially of, or consisting of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O; 0 mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃; wherein 12 mol %≤Li₂O+Na₂O+K₂O≤20 mol % and 0 mol %≤MgO+Ca≤10 mol %.

In embodiments, the substrate 12 has a bulk composition that comprises an alkali aluminosilicate glass comprising, consisting essentially of, or consisting of: about 64 mol % to about 68 mol % SiO₂; about 12 mol % to about 16 mol % Na₂O; about 8 mol % to about 12 mol % Al₂O₃; 0 mol % to about 3 mol % B₂O₃; about 2 mol % to about 5 mol % K₂O; about 4 mol % to about 6 mol % MgO; and 0 mol % to about 5 mol % CaO, wherein: 66 mol %≤SiO₂+B₂O₃+CaO≤69 mol %; Na₂O+K₂O+B₂O₃+MgO+CaO+SrO>10 mol %; 5 mol %≤MgO+CaO+SrO≤8 mol %; (Na₂O+B₂O₃)—Al₂θ₃≤2 mol %; 2 mol %≤Na₂O—Al₂θ₃$6 mol %; and 4 mol %≤(Na₂O+K₂O)—Al₂θ₃≤10 mol %.

In embodiments, the substrate 12 has a bulk composition that comprises SiO₂, Al₂O₃, P₂θ₅, and at least one alkali metal oxide (R₂O), wherein 0.75>[(P₂θ₅ (mol %)+R₂O (mol %))/M₂O₃ (mol %)]≤1.2, where M₂O₃=Al₂O; +B₂O₃. In embodiments, [(P₂θ₅ (mol %)+R₂O (mol %))/M₂O₃ (mol %)]=1 and, in embodiments, the glass does not include B₂O₃ and M₂O₃=Al₂θ₃. The substrate 12 comprises, in embodiments: about 40 to about 70 mol % SiO₂; 0 to about 28 mol % B₂O₃; about 0 to about 28 mol % Al₂O₃; about 1 to about 14 mol % P₂O₅; and about 12 to about 16 mol % R₂O. In some embodiments, the glass substrate comprises: about 40 to about 64 mol % SiO₂; 0 to about 8 mol % B₂O₃; about 16 to about 28 mol % Al₂O₃; about 2 to about 12 mol % P₂O₅; and about 12 to about 16 mol % R₂O. The substrate 12 may further comprise at least one alkaline earth metal oxide such as, but not limited to, MgO or CaO.

In some embodiments, the substrate 12 has a bulk composition that is substantially free of lithium; i.e., the glass comprises less than 1 mol % Li₂O and, in other embodiments, less than 0.1 mol % Li₂O and, in other embodiments, 0.01 mol % Li₂O, and in still other embodiments, 0 mol % Li₂O. In some embodiments, such glasses are free of at least one of arsenic, antimony, and barium; i.e., the glass comprises less than 1 mol % and, in other embodiments, less than 0.1 mol %, and in still other embodiments, 0 mol % of As₂O₃, Sb₂O₃, and/or BaO.

In embodiments, the substrate 12 has a bulk composition that comprises, consists essentially of or consists of a glass composition, such as Corning® Eagle XG® glass, Corning® Gorilla® glass, Corning® Gorilla® Glass 2, Corning® Gorilla® Glass 3, Corning® Gorilla® Glass 4, or Corning® Gorilla® Glass 5.

In embodiments, the substrate 12 has an ion-exchangeable glass composition that is strengthened by either chemical or thermal means that are known in the art. In embodiments, the substrate 12 is chemically strengthened by ion exchange. In that process, metal ions at or near the first major surface 18 of the substrate 12 are exchanged for larger metal ions having the same valence as the metal ions in the glass substrate. The exchange is generally carried out by contacting the substrate 12 with an ion exchange medium, such as, for example, a molten salt bath that contains the larger metal ion. The metal ions are typically monovalent metal ions, such as, for example, alkali metal ions. In one non-limiting example, chemical strengthening of a substrate 12 that contains sodium ions by ion exchange is accomplished by immersing the substrate 12 in an ion exchange bath comprising a molten potassium salt, such as potassium nitrate (KNO₃) or the like. In one particular embodiment, the ions in the surface layer of the substrate 12 contiguous with the first major surface 18 and the larger ions are monovalent alkali metal cations, such as Li⁺ (when present in the glass), Na⁺, K⁺, Rb⁺, and Cs⁺. Alternatively, monovalent cations in the surface layer of the substrate 12 may be replaced with monovalent cations other than alkali metal cations, such as Ag⁺ or the like.

In such embodiments, the replacement of small metal ions by larger metal ions in the ion exchange process creates a compressive stress region in the substrate 12 that extends from the first major surface 18 to a depth (referred to as the “depth of layer”) that is under compressive stress. This compressive stress of the substrate 12 is balanced by a tensile stress (also referred to as “central tension”) within the interior of the substrate 12. In some embodiments, the first major surface 18 of the substrate 12 described herein, when strengthened by ion exchange, has a compressive stress of at least 350 MPa, and the region under compressive stress extends to a depth, i.e., depth of layer, of at least 15 μm below the first major surface 18 into the thickness 22.

Ion exchange processes are typically carried out by immersing the substrate 12 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt, such as, but not limited to, nitrates, sulfates, and chlorides, of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments, when employed with a substrate 12 having an alkali aluminosilicate glass composition, result in a compressive stress region having a depth (depth of layer) ranging from about 10 μm up to at least 50 μm, with a compressive stress ranging from about 200 MPa up to about 800 MPa, and a central tension of less than about 100 MPa.

As the etching processes that can be employed to create the diffractive surface region 20 of the substrate 12 can remove alkali metal ions from the substrate 12 that would otherwise be replaced by a larger alkali metal ion during an ion exchange process, a preference exists for developing the compressive stress region in the display article 10 after the formation and development of the diffractive surface region 20.

### Examples

Embodiments of the present disclosure may be further understood in view of the following examples.

In a first example, the process described herein with respect to FIG. 6A was performed for a 2.048 mm by 2.048 mm sample within a designed wavelength range of 400 nm to 800 nm with 4 discrete heights. Only a normal angle of incidence was considered in this case. Etching heights were determined using equations 8-9 herein and ideal combined surface area percentages were determined using Equations 10-11. Equation 12 was minimized using a suitable optimization algorithm, with the target scattering pattern being a l=2 LG mode and the weighting parameter w was set to 10.

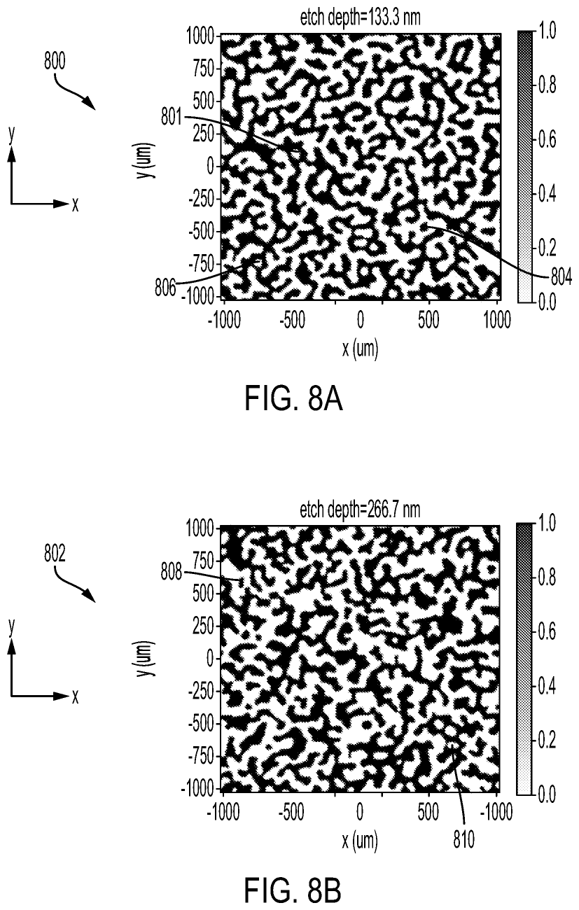

FIGS. 8A and 8B show patterns of etching masks along with associated etching depths. FIG. 8A depicts a plan view of a first etching mask 800 for a first etching depth of λ̅/4=133.3 nm in this example. FIG. 8B depicts a plan view of second etching mask 802 for a second etching depth of λ̅/2=266.7 nm. As shown, both the first etching mask 800 and the second etching mask 802 comprise wormy structures with relatively large contiguous areas at the same level (e.g., having maximum linear dimensions on the order of 100s of microns). Both the first etching mask 800 and the second etching mask 802 also includes surrounded regions 804, 806, 808, and 810 that are relatively small regions (having maximum linear dimensions on the order of 10s of microns) that are completely surrounded by regions that are etched to a different level. The light regions of each of the first and second etching masks 800 and 802 (corresponding to regions of the substrate that are not etched during their associated etching steps) may overlap one another to form regions at the maximum height hₘₐₓ relative to an imaginary base plane, or with dark regions of the other etching mask to form regions having the heights h₁ and h₂ depicted in FIG. 3. The dark regions in each of the first and second etching masks 800 and 802 (correspond to regions of the substrate that are etched to the target etching depth during their associated etching steps) may also overlap with one another to form regions at the minimum height hₘᵢₙ depicted in FIG. 3.

It can be shown that the method described herein generates periodic etching patterns (in both the x and y directions), such that the patterns depicted in FIGS. 8A and 8B can be tiled to cover greater areas. In embodiments, the minimum tile dimension associated with an etching mask may be 2 mm 500 μm to allow design flexibility to find a suitable pattern and prevent any visible scattering intensity inhomogeneity due to the period nature of the pattern.

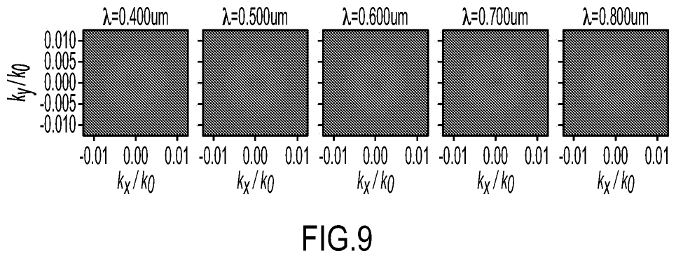

FIG. 9 depicts calculated far field scattering patterns for several wavelengths within the wavelength range of interest for this example. All scattering patterns show a characteristic “donut shape” and closely resemble an LG mode with l=2. The peak scattering angle of the scattering patterns was 0.25°, demonstrating that the scattering pattern should result in relatively low haze.

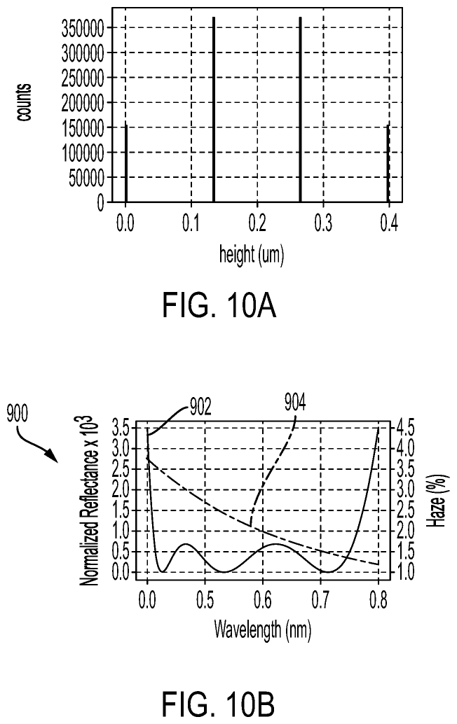

FIG. 10A depicts a histogram of etch depths (representing the combined surface area percentage associated with each of the heights hⱼ described herein). The frequency of each of the heights agrees very well with an ideal ratio of 0.147:0.353:0.353:0.147. That is, in embodiments, a first combined surface area percentage (A₁) associated with the first plurality of regions 22a at the height hₘₐₓ may approximately equal (e.g., be within 5% of) a second combined surface area percentage (A₂) associated with the second plurality of regions 22b at the height hₘᵢₙ (see FIG. 3). In embodiments, a third combined surface area percentage (A₃) associated with the third plurality of regions 22c at the height h₁ may approximately equal (e.g., be within 5% of) a fourth combined surface area percentage (A₄) associated with the fourth plurality of regions 22d at the height h₂. In embodiments, A₄+>A₁. In embodiments, A₄+>A₂. In embodiments, A₃>A₁. In embodiments, A₃>A₂. In embodiments, A₁ and A₂ are less than half of A₃ or A₄. In embodiments A₁+A₂<A₃. In embodiments A₁+A₂<A₄. In embodiments, when there are four heights in the discrete distribution of heights, A₁, A₂, A₃, and A₄ are each less than 40%. In embodiments when there are two heights in the discrete distribution of heights, both A₁ (associated with hₘₐₓ) and A₂ (equal to hₘₐₓ−λ̅/4) equal 50%. In embodiments, hₘᵢₙ is at least 100 nm (e.g., at least 105 nm, at least 110 nm, at least 115 nm, at least 120 nm, at least 125 nm, at least 130 nm, at least 135 nm, at least 140 nm, at least 145 nm, at least 150 nm, at least 200 nm, at least 250 nm, at least 300 nm, at least 350 nm, at least 400 nm, at least 450 nm, at least 500 nm, or even greater) less than hₘₐₓ.

FIG. 10B depicts a plot 900 including a first plot 902 of calculated normalized reflectance (assuming the untextured version has 1 reflectance) and a second plot 904 of calculated transmission haze. As shown by the plot 902, the specular reflectance is greatly reduced as compared to the textured version, with maximum specular reflectance occurring at boundaries of the wavelength range of interest, but still corresponding to a reduction multiple of 0.0035, such that the specular reflectance is 0.35% of the value of the untextured version. As shown by the plot 805, a maximum haze of around 3.7% is observed at the 400 nm wavelength, but the average is around 2.5% throughout the wavelength range of interest. These results demonstrate the capability of the patterns generated by the method described herein of providing beneficial specular reflectance reduction while providing relatively low haze.

A second example was fabricated via the method 700 described herein with respect to FIG. 7. The second example included a diffractive surface region with regions at only two heights relative to an imaginary base plane. The pattern was determined over the wavelength range of interest of 400 nm to 800 nm for normal incidence. The pattern for the regions was determined by the method 600 described herein with respect to FIG. 6A. A single etching mask was disposed on the sample. The sample was a 4-inch wafer of Gorilla Glass® manufactured by Corning Incorporated having a thickness of 0.7 mm. After deposition and patterning of a resist, the wafer the wafter was exposed to an Etchant (0.15% HF/1% HFNO₃) for a duration of 175 seconds to achieve an etch depth measured by a stylus of 156.5 nm. The general sequence of processing steps for a typical photolithography process, as consistent with Example 2, is as follows: substrate preparation (clean and dehydration followed by an adhesion promoter for spin-coatable resist, e.g., hexamethyl disilazane (HMDS), photoresist spin coat, prebake, exposure (e.g., via UV radiation, to elevated temperatures), and development, followed by a wet etching process to transfer the binary image onto glass. The final step is to strip the resist (e.g., via exposure to a suitable solvent) after the resist pattern has been transferred into the underlying layer. In some cases, post bake and post exposure bake steps are required to ensure resist adhesion during wet etching process.

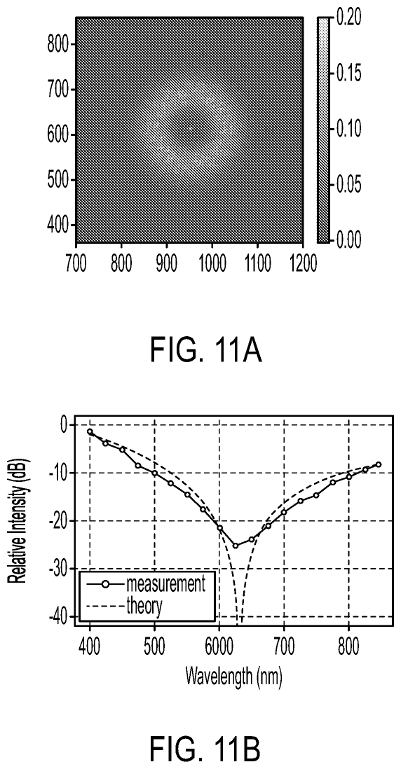

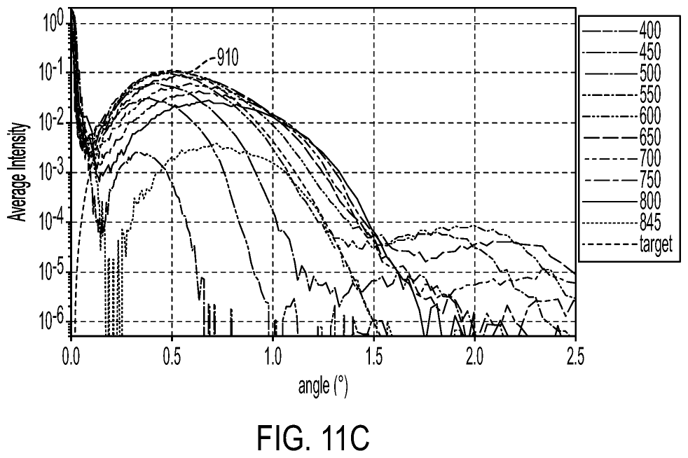

Light from a super-continuum source was directed through a beam splitter onto the diffractive surface region of the sample and measurements of specular reflectance and scattering were taken at a plurality of wavelengths. Reflected and scattered light was directed by the beam splitter onto a camera and the relative intensity at various scattering angles was measured. FIG. 11A depicts an intensity map corresponding to the imaged scattering pattern. As shown, resemblance to an LG mode was achieved, but the central dot indicates that specular reflections were still visible. FIG. 11B depicts a chart of measured and calculated spectral reflection intensity. As shown, good agreement with theory was achieved. Reductions of up to 25 dB relative to an untextured version of the sample was achieved (corresponding to measured specular reflectance of 0.01% at a wavelength of about 620 nm). The observed specular reflectance was less than 4% throughout the wavelength range from 400 nm to 840 nm.

Azimuthally averaged scattering intensities at various scattering angles were also calculated. The results are depicted in FIG. 11C. The dashed line 910 in FIG. 11C represents a scattering pattern associated with the LG mode target scattering distribution, comprising a maximum intensity scattering angle of about 0.5°. As shown, the wavelengths around 600 nm closely approximate the target scattering distribution, while wavelengths at the lower end of the wavelength range have peak scattering angles less than 0.5° and wavelengths 700 nm above have peak scattering angles greater than 0.5°, but still less than 2.5°. Such results demonstrate the efficacy of the articles described herein at providing favorable specular reflectance performance while still providing low haze.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, “a” is intended to comprise one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to comprise everything within the scope of the appended claims and their equivalents.

1. A display article comprising:
a first major surface:
a second major surface opposing the first major surface; and
a diffractive surface region formed in the first major surface, wherein, within the diffractive surface region, the first major surface comprises a plurality of regions disposed at a discrete distribution of heights measured relative to an imaginary base plane extending through the display article and parallel to the first major surface, wherein:
the plurality of regions are arranged such that a specular reflectance of light incident on the first major surface within a wavelength range of interest greater than or equal to a minimum wavelength λₘᵢₙ and less than or equal to a maximum wavelength λₘₐₓ at angles of incidence on the first major surface ranging from a minimum angle of incidence θₘᵢₙ to a maximum angle of incidence θₘₐₓ is reduced by at least a factor of 10 as compared to an untextured version of the first major surface not including the diffractive surface region, and
differences between heights in the discrete distribution of heights are within 5% of integer multiples of λ̅/4, where
$$\overline{λ} = {( \frac{{λ}_{min}^{′ - 1} + {λ}_{max}^{′ - 1}}{2} )}^{- 1} ,$$
λ′ₘᵢₙ=λₘᵢₙ/cos θₘᵢₙ, and λ′ₘₐₓ=λₘₐₓ/cos θₘₐₓ.

2. The display article of claim 1, wherein the diffractive surface region scatters the light in a far-field scattering pattern with a peak scattering angle that is less than or equal to 1.5° over the wavelength range of interest.

3. The display article of claim 2, wherein the peak scattering angle is less than or equal to 0.5° over at least a portion of the wavelength range of interest.

4. The display article of claim 2, wherein the far-field scattering pattern approximates a Laguerre-Gaussian mode.

5. The display article of claim 1, wherein:
λₘᵢₙ is greater than or equal to 380 nm and λₘₐₓ is less than or equal to 1200 nm, and
θₘᵢₙ is greater than or equal to 0° and θₘₐₓ is less than or equal to 75°.

6. The display article of claim 1, wherein λₘᵢₙ=400 nm and λₘₐₓ=800 nm.

7. The display article of claim 1, wherein the specular reflectance is reduced by at least a factor of 100 as compared to the untextured version of the first major surface.

8. The display article of claim 1, wherein the plurality of regions have a minimum feature size that is greater than or equal to 1 μm.

9. The display article of claim 1, wherein the plurality of regions are arranged in a pattern that is periodic in two directions that are perpendicular to one another.

10. The display article of claim 9, wherein the pattern comprises at least one surrounded region that is completely surrounded by regions having different heights relative to the imaginary base plane than the surrounded region.

11. The display article of claim 1, wherein a transmitted haze of the light incident on the first major surface is less than or equal to 4% throughout an entirety of a wavelength range from 400 nm to 800 nm.

12. The display article of claim 1, wherein the regions of the plurality of regions at each height of the discrete distribution of heights occupy a combined surface area percentage of the diffractive surface region that is predetermined to minimize the specular reflectance.

13. The display article of claim 12, wherein the discrete distribution of heights comprises three or more heights, wherein the discrete distribution of heights comprises at least four heights, thet least four heights comprising a minimum height hₘᵢₙ, a second height within 5% of hₘᵢₙ+λ̅/4, a third height within 5% of hₘᵢₙ+λ̅/2, and a fourth height within 5% of hₘᵢₙ+3λ̅/4, wherein:
a first plurality of regions having the minimum height occupy a first combined surface area percentage of the diffractive surface region, and
the first combined surface area percentage is less than a second combined surface area percentage occupied by a second plurality of regions having the second height
a third plurality of regions having the third height occupy a third combined surface area percentage of the diffractive surface region,
a fourth plurality of regions having the fourth height occupy a fourth combined surface area percentage of the diffractive surface region,
the first combined surface area percentage is within 5% of the fourth combined surface area percentage,
the second combined surface area percentage is within 5% of the third combined surface area percentage, and
the combined surface area percentage associated with each height is less than or equal to 40%.

14. (canceled)

15. (canceled)

16. (canceled)

17. (canceled)

18. A glass display article comprising:
a first major surface;
a second major surface opposing the first major surface; and
a diffractive surface region formed in the first major surface, wherein, within the diffractive surface region, the first major surface comprises:
a first plurality of regions comprising a first plurality of heights that are within 5% of an average of the first plurality of heights at a maximum height hₘₐₓ measured from an imaginary base plane extending through the display article and parallel to the first major surface, the first plurality of regions occupying a first combined surface area percentage of the diffractive surface region; and
a second plurality of regions comprising a second plurality of heights that are within 5% of an average of the second plurality of heights at a minimum height hₘᵢₙ measured from the imaginary base plane, the second plurality of regions occupying a second combined surface area percentage of the diffractive surface region, wherein:
the first plurality of regions and the second plurality of regions are arranged in a predetermined pattern based on a predicted specular reflectance of light incident on the first major surface within a wavelength range of interest greater than or equal to a minimum wavelength λₘᵢₙ and less than or equal to a maximum wavelength λₘₐₓ at angles of incidence on the first major surface ranging from a minimum angle of incidence θₘᵢₙ to a maximum angle of incidence θₘₐₓ,
hₘₐₓ−hₘᵢₙ is within 5% of an integer multiple of λ̅/4, where
$$\overline{λ} = {( \frac{{λ}_{min}^{′ - 1} + {λ}_{max}^{′ - 1}}{2} )}^{- 1} ,$$
λ′ₘᵢₙ=λₘᵢₙ/cos θₘᵢₙ, and λ′ₘₐₓ=λₘₐₓ/cos θₘₐₓ, and
an average measured specular reflectance of the first major surface is less than or equal to 2.5% over the wavelength range of interest within the angles of incidence.

19. The glass display article of claim 18, wherein diffractive surface region scatters the light in a far-field scattering pattern with a peak scattering angle that is less than or equal to 1.5° over the wavelength range of interest.

20. (canceled)

21. (canceled)

22. The glass display article of claim 18, wherein:
λₘᵢₙ is greater than or equal to 380 nm and λₘₐₓ is less than or equal to 1200 nm, and
θₘᵢₙ is greater than or equal to 0° and θₘₐₓ is less than or equal to 75°.

23. (canceled)

24. (canceled)

25. (canceled)

26. (canceled)

27. (canceled)

28. (canceled)

29. (canceled)

30. (canceled)

31. A method of forming a diffractive surface region of a substrate for a display article, the method comprising:
determining a pattern for a plurality of regions on a first major surface of the substrate, wherein each region of the plurality of regions comprises a surface area disposed at a height measured relative to an imaginary base plane extending through the display article and parallel to the first major surface, wherein the plurality of regions comprises a discrete distribution of heights;
disposing one or more etching masks on the first major surface that allow etching only on select regions of the first major surface for forming at least some of the plurality of regions; and
after each etching mask of the one or more etching mask is disposed on the first major surface, contacting the display article with an etchant for a period of time so as form the plurality of regions comprising the discrete distribution of heights in the substrate, such that differences between the heights in the discrete distribution of heights are within 5% of integer multiples of λ̅/4, where
$$\overline{λ} = {( \frac{{λ}_{min}^{′ - 1} + {λ}_{max}^{′ - 1}}{2} )}^{- 1} ,$$
λₘᵢₙ is a minimum wavelength of a wavelength range of interest, λₘₐₓ is a maximum wavelength over the wavelength range of interest, [θₘᵢₙ, θₘₐₓ] defines a range of angles of incidence over which it is desired to minimize specular reflectance of the display article, λ′ₘᵢₙ=λₘₐₓ cos λₘᵢₙ, and λ′ₘₐₓ=λₘᵢₙ cos θₘₐₓ.

32. The method according to claim 31, wherein determining the pattern for the plurality of regions comprises determining an ideal combined surface area percentage for each height in the discrete distribution of heights using the following relation
FA=1,
where A is a vector having N entries, with N corresponding to a number of heights in the discrete distribution of heights, 1 is a unity column vector with N entries, and F is an N×N matrix, with each value Fᵢⱼ being computed as
$${F}_{ij} = {\int }_{{k}_{min}^{′}}^{{k}_{max}^{′}} \frac{dk}{k} cos ( k \cdot \frac{\overline{λ} ( i - j )}{2} ) .$$

33. The method of claim 32, wherein determining the pattern for the plurality of regions comprises:
generating an initial pattern for the plurality of regions;
calculating an estimated far-field scattering pattern ü(λ) by approximating incoming light as a uniform field and the diffractive surface region as only inducing a phase shift in reflected light; and
updating the initial pattern to reduce a difference between ü(λ) and a target scatting pattern u(λ) using an optimization algorithm.

34. (canceled)

35. (canceled)

36. (canceled)

37. (canceled)

38. The method of any of claims 31-37, wherein the one or more etching masks comprises at least two etching masks such that the discrete distribution of heights comprises at least 4 heights.

39. (canceled)

40. (canceled)

41. The method of claim 31, wherein the pattern is periodic in at least two directions that are perpendicular to one another.
